(19) United States
(12) Patent Application Publication
(10) Pub. No.: US 2013/0270102 A1
(43) Pub. Date: Oct. 17, 2013

(54) METHOD FOR PRODUCING FLUORINATED POLYSILANES

(71) Applicants: Norbert Auner, Glashuetten (DE); Sven Holl, Gueckingen (DE); Christian Bauch, Muldenstein-Muldestausee (DE); Rumen Deltschew, Leipzig (DE); Javad Mohsseni, Bitterfeld-Wolfen (DE)

(72) Inventors: Norbert Auner, Glashuetten (DE); Sven Holl, Gueckingen (DE); Christian Bauch, Muldenstein-Muldestausee (DE); Rumen Deltschew, Leipzig (DE); Javad Mohsseni, Bitterfeld-Wolfen (DE)

(73) Assignee: Spawnt Private S.a.r.l., Luxembourg (LU)

(21) Appl. No.: 13/823,731

(22) PCT Filed: Sep. 14, 2011
(86) PCT No.: PCT/EP11/65968

§ 371 Date: Jun. 21, 2013

(30) Foreign Application Priority Data
Sep. 14, 2010 (DE) 10 2010 045 260.2

(51) Int. Cl. C01B 33/03; C01B 33/107

(52) U.S. Cl. CPC C01B 33/03; C01B 33/107
USPC 204/156

(57) ABSTRACT

The invention relates to a method for producing fluorinated polysilanes. Hydrogen fluoride and/or hexafluorosilicic acid, which are obtained in particular during acid digestion of mineral phosphates in the production of phosphate fertilisers, are used for the production of SiF4. The SiF4 obtained is thermally or plasma-chemically converted to fluorinated polysilane. The method is particularly efficient and cost-effective.

The present invention relates to a process for preparing fluorinated polysilanes.

The industrial production of phosphate-containing fertilizers frequently proceeds from rocks containing compounds such as fluorapatite Ca₅(PO₄)₃F as impurities. The treatment of such rocks with sulfuric acid in fertilizer production releases hydrogen fluoride HF as a by-product. Silicon dioxide SiO₂ likewise present in the rocks reacts with at least some of this HF to give tetrafluorosilane SiF₄.

Ca₅(PO₄)₃F+5 H₂SO₄5 →CaSO₄+3 H₃PO₄+HF

4 HF+SiO₂→SiF₄+2 H₂O

Both compounds are scrubbed out of the reaction offgas with water in industrial production, and are then in the form of an aqueous solution of hexafluorosilicic acid H₂SiF₆ and/or in the form of hydrofluoric acid. H₂SiF₆ cannot be isolated in pure form, and instead decomposes in the course of dehydration of the solution to give HF and SiF₄ in a reversal of the formation reaction. By addition of suitable alkali metal compounds, it is possible to precipitate alkali metal hexafluorosilicates out of the solution.

2 HF+SiF₄→H₂SiF₆

2 NaOH+H₂SiF₆→Na₂SiF₆+2 H₂O

2 NaF+H₂SiF₆→Na₂SiF₆+2 HF

It is known from the prior art that admixing of a hexafluorosilicic acid solution with concentrated sulfuric acid can bring about the dehydration and release SiF₄. The alkali metal hexafluorosilicates can be decomposed by heating, for example to about 650° C. for sodium hexafluorosilicate, to alkali metal fluorides and SiF₄.

For example, U.S. Pat. Nos. 4,756,896, WO 1983/02443 A1, WO 1984/02514 A1 or WO 1984/02539 A1 disclose the use of SiF₄ or of Na₂SiF₆ for preparation of elemental silicon by reaction with alkali metals. Suitable workup, for example washing with water, or an adapted reaction regime, for example high reaction temperatures which lead to melting of one or both reaction products, allows the alkali metal fluorides formed as by-products to be separated from the silicon obtained.

iF₄+4 Na→Si+4 NaF

For example, P. L. Timms, R. A. Kent, T. C. Ehlert, J. L. Margrave, Journal of the American Chemical Society 87 (1965) 2824-2828 report that passage of SiF₄ over elemental silicon at 1150° C. and 0.1-0.2 torr, freezing of the SiF₂ formed at −196° C. and subsequent thawing produces (SiF₂)ₓ. The polymer melts when heated under reduced pressure and releases a mixture of perfluorinated silanes SiF₄ up to at least Si₁₄F₃₀. What remains is a silicon-rich polymer (SiF)ₓ which decomposes at temperatures of more than 400° C. to give SiF₄ and Si.

5/x (SiF)ₓ→SiF₄+4 Si

For example, U.S. Pat. No. 4,070,444A discloses that the preparation and subsequent thermal decomposition of polyfluorosilane can also be used for purification of metallurgical silicon.

SiF₄+Si→2/x (SiF₂)ₓ

2/x (SiF₂)ₓ→Si+SiF₄

It is known from DE 10 2005 024 041 A1, for example, that SiF₄ can be reduced with H₂ in a plasma to obtain (SiF₂)ₓ. In a second step, the polymer is then decomposed thermally to give elemental silicon.

2 SiF₄+2 H₂→2/x (SiF₂)ₓ+4 HF

2/x (SiF₂)ₓ→Si+SiF₄

For example, US 2004/0250764 A1 describes production of a plasma in a rotary tube reactor, in which SiF₄ reacts with hydrogen. The rotating motion of the reactor transports silicon seed grains, which fall through the plasma zone, and elemental silicon is deposited thereon within this plasma zone.

This reduction with hydrogen leads to real silicon recovery from SiF₄, while the above-described process using silicon as a reducing agent is effectively merely a transport reaction.

P. L. Timms, R. A. Kent, T. C. Ehlert, J. L. Margrave, Journal of the American Chemical Society 87 (1965) 2824-2828 report that (SiF₂)ₓ reacts with hydrofluoric acid (20%) in a redox reaction with release of hydrogenated silanes SiH₄ up to at least Si₆H₁₄ as well as a large amount of hydrogen and SiO₂, according to the simplified illustrative equation:

7/x (SiF₂)ₓ+10 H₂O→Si₂H₆+5 SiO₂+14 HF

It is an object of the present invention to provide a process for preparing fluorinated polysilanes, with which fluorinated polysilanes can be prepared particularly efficiently and inexpensively.

This object is achieved in accordance with the invention by a process for preparing fluorinated polysilanes, having the following steps:
using HF and/or hexafluorosilicic acid (H₂SiF₆) for preparation of SiF₄; and
thermally or plasma-chemically converting the SiF₄ to the fluorinated polysilane.

Advantageous embodiments and developments of the process according to the invention are characterized in the dependent claims and are evident from the description which follows.

More particularly, HF and/or hexafluorosilicic acid obtained in the acidic digestion of mineral phosphates in the production of phosphate fertilizers is used.

To obtain the hexafluorosilicic acid, in one embodiment of the process according to the invention, HF is converted to the transport and storage form H₂SiF₆. This allows the HF to be transported and stored in a stable manner, the transport and storage form H₂SiF₆ being less corrosive and toxic than free HF. Moreover, H₂SiF₆ is the direct starting material for the preparation of the SiF₄ required for the plasma process. More particularly, HF which is obtained in the acidic digestion of mineral phosphates in the production of phosphate fertilizers is used.

In a further embodiment of the process according to the invention, the yield of SiF₄ from the conversion of H₂SiF₆ can be increased by up to a maximum of 50% by adding SiO₂-containing starting materials, the SiO₂-containing starting material used with preference being quartz sand. Useful further starting materials include, for example, diatomaceous earth, rice ash, silicates, silicatic glasses.

In a further embodiment of the process according to the invention, HF formed by thermal or plasma-chemical conversion of the SiF₄ is recycled. As a result, the HF is recycled into the process according to the invention and disposal of the HF is superfluous.

Preferably in accordance with the invention, the fluorinated polysilane obtained is used for preparation of high-purity silicon.

In a further embodiment of the process according to the invention, the high-purity silicon obtained in the process has impurities which disrupt the semiconductor properties and/or dopants each with a proportion of less than 10 ppm, preferably less than 1 ppm, more preferably less than 1 ppb. These impurities and/or dopants are elements of main group 3, 4, and/or 5 of the periodic table, especially boron, aluminum, lead, phosphorus, tin, arsenic, antimony, and metals of main group 2, for example calcium, and transition metals, for example iron. Such impurities and/or dopants can be determined by elemental analysis or mass spectrometry analyses, more particularly mass spectrometry with inductively coupled plasma (ICP-MS).

High-purity silicon can be used, for example, in the semiconductor industry and/or photovoltaics.

The conversion to fluorinated polysilanes (PFS) can be effected by plasma-chemical means, in which case SiF₄ is reacted with hydrogen in the plasma. In this case, a reduction to form HF and PFS takes place approximately according to the following reaction equation: SiF₄+H₂→SiF₂+2 HF. The SiF₂ then polymerizes to give the PFS: nSiF₂→(SiF₂)ₙ. The PFS can then be converted thermally, for example, to silicon and SiF₄, and the latter can be recycled back into the process.

In a further embodiment, SiF₄ and hydrogen are converted to fluorinated polysilane with production of a plasma, working in relation to the plasma reaction with an energy density of less than 10 Wcm⁻³, preferably of 0.2-2 Wcm⁻³.

Energy density is understood here to mean the incident power at the moment of gas discharge, divided by the gas volume excited.

For the process according to the invention, the plasma can be produced using, for example, electrical voltage or electromagnetic alternating fields. Preference is given to high-frequency glow discharges at relatively low pressures (a few hPa).

In addition, the process according to the invention features a lower hydrogen content in the starting mixture compared to the prior art. For instance, the invention operates with a mixing ratio of fluorosilane:hydrogen of 1:0-1:2, as a result of which the incident energy per equivalent of fluorosilane to be decomposed is distinctly reduced once again. This is preferably about 800 to 20 000 kJ/mol, particularly 850-1530 kJ/mol, of fluorosilane.

In a further embodiment of the process according to the invention, the gas mixture used (fluorosilane and hydrogen) may additionally be diluted by an inert gas and/or comprise additions which promote plasma production. However, the addition of inert gases is not obligatory in the process according to the invention.

In another embodiment of the process according to the invention, fluorosilane is added to the hydrogen stream after it has passed through a plasma zone (remote plasma). In this case, either the hydrogen gas or the fluorosilane may be diluted by an inert gas and/or comprise additions which promote plasma generation. The fluorosilane can also be used diluted with hydrogen.

In a further embodiment of the invention, the working pressure utilized in the process for plasma-chemical conversion to fluorinated polysilanes may be in the range from 0.1 to 100 hPa, preferably from 0.5 to 20 hPa, more preferably 0.6 to 2 hPa.

In a further embodiment, the thermal or plasma-chemical conversion to fluorinated polysilane (PFS) can be effected, in which case the temperature of the reactor parts in which the process according to the invention is performed and where the fluorinated polysilane is deposited is kept at from −70° C. to 300° C., especially −20° C. to 280° C. In general, the temperature is kept relatively low to avoid the formation of silicon. The PFS can then be converted further, for example by thermal means to silicon and SiF₄, in which case the latter can be recycled back into the process.

In a further embodiment of the invention, the working pressure utilized in the process for thermal conversion to fluorinated polysilanes may be in the range from 0.1 to 1000 hPa, for example 100 hPa.

In a further embodiment of the invention, the thermal conversion of the SiF₄ may lie at temperatures exceeding 1050° C., preferably from 1200° C. to 1500° C., more preferably from 1200° C. to 1300° C.

Specifically, it is thus a feature of one embodiment of the process according to the invention that the waste products H₂SiF₆ and/or HF from the fertilizer industry are used for preparation of SiF₄. SiF₄ is converted to fluorinated silane. It is possible to obtain valuable products from this, such as high-purity silicon, which are used, for example, in photovoltaics.

The process according to the invention, i.e. the overall process, can be performed in carbon-free mode, for example with renewable electrical energy, such that the known CO₂ problem is immaterial.

In a further embodiment of the process according to the invention, the preparation of high-purity silicon can be performed without addition of carbon from HF and/or hexafluorosilicic acid (H₂SiF₆), in which case SiF₄ is prepared from HF and/or hexafluorosilicic acid (H₂SiF₆), and this in turn is converted thermally or plasma-chemically to fluorinated polysilanes and then to silicon. This enables more environmentally friendly preparation of high-purity silicon compared to silicon preparation from chlorinated polysilanes, in which carbon frequently has to be added.

It is a feature of a further embodiment of the process according to the invention that the fluorinated polysilane obtained is used for preparation of hydrogenated polysilanes, the hydrogenated polysilanes thus being prepared in a particularly efficient, inexpensive and environmentally friendly manner.

In a further embodiment of the process according to the invention, hydrogenation of the fluorinated polysilanes affords partly hydrogenated and perhydrogenated compounds, meaning that some or all of the fluorine atoms have been replaced by hydrogen atoms. The hydrogenation can be performed in inert solvents such as ethers, toluene etc. and the hydrogenation should be conducted at minimum temperatures (RT or lower) in order to suppress decomposition of the polysilanes formed.

In a further embodiment of the process according to the invention, hydrogenation is accomplished using hydride salts such as LiH, NaH or CaH₂.

Preferably, in at least one further embodiment of the process according to the invention, hydrogenation is accomplished using complex hydrides, preferably NaAlH₄, LiAlH₄, NaBH₄, more preferably NaAlH₄, or else using suitable catalytic processes with hydrogen or suitable hydrogen carrier compounds.

In a further embodiment of the process according to the invention, the reaction conditions in the hydrogenation are selected such that the number n of silicon atoms in the fluorinated polysilanes is not reduced. More particularly, the temperature is kept preferably within the range from −40° C. to 25° C., more preferably within the range from −20° C. to 15° C., especially within the range from −10° C. to 5° C. In other words, there is no splitting between the Si—Si bonds of the fluorinated polysilanes in the hydrogenation.

In a further embodiment of the process according to the invention, the reaction conditions in the hydrogenation are selected such that the Si—Si bonds of the fluorinated polysilane are split and hydrogenated polysilanes are formed, the number n of silicon atoms in the hydrogenated polysilanes being smaller compared to the number n of silicon atoms in the fluorinated polysilanes. In other words, the hydrogenated polysilanes formed are shorter-chain than the fluorinated polysilanes used. This is preferably effected by free-radical hydrogenation at temperatures exceeding 0° C. or by partial hydrogenation by insertion of hydrogen halide into the Si—Si bond, preferably using HF.

In a further embodiment of the process according to the invention, the fluoride salts formed as by-products are used as starting materials for aluminum production or for fluoridation of drinking water. This eliminates disposal and disposal costs for the fluoride salts, the fluoride salts being processed further inexpensively.

In a further embodiment of the process according to the invention, the fluorinated polysilane is used for preparation of fluorinated and/or partly fluorinated oligosilanes.

In a further embodiment of the process according to the invention, fluorinated polysilane is used by reaction with HF for preparation of hydrogenated and/or partly hydrogenated oligosilanes, the HF originating at least partly from the polymerization step for preparation of the fluorinated polysilanes.

### WORKING EXAMPLE

An H₂SiF₆ solution from fertilizer production is admixed with 10-15% by mass of quartz sand. HF gas is passed into the mixture until no further gas is taken up. The concentrated H₂SiF₆ solution is transferred together with the rest of the SiO₂-containing material into an acid-resistant metal vessel and admixed gradually with concentrated H₂SO₄ while stirring. The exiting gas is collected in a cold trap cooled with liquid nitrogen. After reaction has ended, the SiF₄ is recondensed by cautious thawing, and thus freed of residues of water and HF.

A 2 L balloon is filled with a mixture of H₂ and SiF₄ (1:1; 45 mmol). The gas mixture formed is passed through a quartz tube having an internal diameter of 13 mm at a pressure of 10-20 hPa and a weak glow discharge (˜10 W) is generated within the tube by means of high voltage between two electrodes. Thereafter, over a distance of 4.2 cm, pulsed microwave radiation (2.45 GHz) with a pulse energy of 800 W and a pulse time of 1 ms, followed by a pause from 19 ms, is introduced, corresponding to a mean power of 40 W. After about 7 h, 0.63 g (approx. 20% of theory) of a white to brownish solid comprising fluorinated polysilane is obtained. In the course of heating to 800° C. under reduced pressure, the material decomposes to form silicon.

1. A method for preparing fluorinated polysilanes, comprising the following steps:
using HF or hexafluorosilicic acid (H₂SiF₆) for preparation of SiF₄; and
thermally or plasma-chemically converting the SiF₄ to the fluorinated polysilane.

2. The method according to claim 1, wherein HF or hexafluorosilicic acid obtained in the acidic digestion of mineral phosphates in the production of phosphate fertilizers is used.

3. The method according to claim 1 or 2, wherein HF is converted to the transport and storage form H₂SiF₆.

4. The method according to claim 1, wherein the yield of SiF₄ from the conversion of H₂SiF₆ is increased by addition of SiO₂-containing starting materials.

5. The method according to claim 1, wherein the fluorinated polysilane obtained is used for preparation of high-purity silicon.

6. The method according to claim 1, wherein the fluorinated polysilane obtained is used for preparation of hydrogenated polysilanes.

7. The method according to claim 6, wherein hydride salts are used for hydrogenation.

8. The method according to according to claim 6 or 7, wherein NaAlH₄ is used.

9. The method according to claim 1, wherein the fluoride salts formed as a by-product are used as starting materials for aluminum production or for fluoridation of drinking water.

10. The method according to claim 1, wherein the fluorinated polysilane is used for preparation of fluorinated or partly fluorinated oligosilanes.

11. The method according to claim 1, wherein the fluorinated polysilane is used through reaction with HF for preparation of hydrogenated or partly hydrogenated oligosilanes.

12. The method according to claim 11, wherein the HF originates at least partly from the polymerization step for preparation of the fluorinated polysilanes.

13. The method according to claim 1, wherein the fluorinated polysilanes are prepared using hydrogen.

14. The method according to claim 1, wherein the method is performed in carbon-free mode.

15. The method according to claim 1, wherein HF formed by thermal or plasma-chemical conversion is recycled.
